(19) United States
(12) Patent Application Publication
(10) Pub. No.: US 2015/0186616 A1
(43) Pub. Date: Jul. 2, 2015

(54) PLANS OF CARE ACROSS A LIFE CONTINUUM

(71) Applicant: CERNER INNOVATION, INC., KANSAS CITY, KS (US)

(72) Inventors: MICHAEL A. ASH, Omaha, NE (US); DANA M. KOSMALA-RUNKLE, OLATHE, KS (US); FRANCES P. WU, KANSAS CITY, MO (US)

(21) Appl. No.: 14/587,215

(22) Filed: Dec. 31, 2014

Related U.S. Application Data
(60) Provisional application No. 61/922,161, filed on Dec. 31, 2013.

(51) Int. Cl. G06F 19/00

(52) U.S. Cl. CPC G06F 19/3481; G06F 19/3431; G06F 19/345

(57) ABSTRACT

Methods, systems, and computer-readable media are provided for generating a care plan for a patient related to a disease condition or a clinical event. Upon receiving a request for the care plan for the patient, a care plan template having a plurality of different sections is generated. A plurality of different care plans related to the disease condition or the clinical event is determined, and a first care plan is selected. Information from the first care plan is parsed based on the plurality of sections, and the parsed information is populated into the template. The populated template is communicated for presentation on a user interface. Methods, systems, and media herein are also directed to generating and displaying graphical depictions of a patient's care plans.

### CROSS-REFERENCE TO RELATED APPLICATIONS

This application, having attorney docket number CRNI.198860 and entitled “Plans of Care Across a Life Continuum,” claims the benefit of priority to U.S. Provisional Application No. 61/922,161, filed Dec. 31, 2013 and entitled “Plans of Care Across a Life Continuum.” The entirety of the aforementioned application is incorporated by reference herein.

### BACKGROUND

When a healthcare provider encounters a new patient or when an existing patient presents with a new problem, the healthcare provider generally constructs a plan of care for the patient. This is typically a labor-intensive process that requires the provider to customize and craft each component of the care plan including medications, alert parameters, other orderables, and the like. While clinical decision support tools may be available to assist in this process, the healthcare provider relies heavily on his or her own clinical knowledge. Although the resulting plan may be adequate for the patient's care, it may be more expensive, less effective, or may have lower patient compliance than other care plans. However, currently the healthcare provider has no ability to compare different patient care plans in order to select the most appropriate one in terms of effectiveness, cost, and compliance. In addition, although the healthcare provider's customized care plan may be suitable for the provider's own purposes, such care plans are not easily transferable to other care providers since they may lack information that is helpful to those other providers.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The present invention is defined by the claims.

In brief and at a high level, this disclosure describes, among other things, methods, systems, and computer-readable media for creating a catalog of care plans that include lifetime care plans, condition-based care plans, and episodic care plans. The care plans are structured in a uniform way designed to not only improve patient outcomes, but to increase communication across different healthcare venues caring for the patient, enhance comparisons between different care plans, and facilitate patient involvement in the plan of care, all in a cost-effective manner.

This disclosure also contemplates a graphical user interface (GUI) that enables a healthcare provider to view the different care plans that have been implemented for a patient over the course of the patient's life. The GUI is interactive. For instance, selecting a plan initiates presentation of a summary view detailing important information about the plan including, for example, key parameters associated with the plan, previous plans used, plan costs, side effects associated with the plan, and the like.

Additionally, this disclosure describes a patient care plan summary view accessible to the patient via, for example, a patient portal. The patient care plan summary view allows the patient to view information associated with his or her plan of care. The patient summary view presents information in such a manner that the patient can easily see what he is trying to achieve, what he should be doing, what he should not be doing, and what should be reported to the patient's healthcare provider. As well, the patient summary view provides information on how well the patient, or the patient's care team is meeting certain goals or outcomes associated with the care plan.

### BRIEF DESCRIPTION OF THE DRAWINGS

Embodiments are described in detail below with reference to the attached drawings figures, wherein:

FIG. 1 is a block diagram of an exemplary computing environment suitable to implement embodiments of the present invention;

FIG. 2 is a block diagram of an exemplary system for generating care plans suitable to implement embodiments of the present invention;

FIG. 3 depicts an exemplary plan of care for the condition of diabetes in accordance with an embodiment of the present invention;

FIGS. 4-5 depict exemplary graphical user interfaces illustrating a timeline view of a patient's plans of care in accordance with an embodiment of the present invention;

FIG. 6 depicts an exemplary provider care plan summary in accordance with an embodiment of the present invention; and

FIG. 7 depicts an exemplary patient care plan summary in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are directed to methods, systems, and computer-readable media for creating a catalog of care plans that include lifetime care plans, condition-based care plans, and episodic care plans. The care plans are structured in a uniform way designed to not only improve patient outcomes, but to increase communication across different healthcare venues caring for the patient, enhance comparisons between different care plans, and facilitate patient involvement in the plan of care, all in a cost-effective manner.

This disclosure also contemplates a graphical user interface (GUI) that enables a healthcare provider to view the different care plans that have been implemented for a patient over the course of the patient's life. The GUI is interactive. For instance, selecting a plan initiates presentation of a summary view detailing important information about the plan including, for example, key parameters associated with the plan, previous plans used, plan costs, side effects associated with the plan, and the like.

Additionally, this disclosure describes a patient care plan summary view accessible to a patient via, for example, a patient portal. The patient care plan summary view allows the patient to view information associated with his or her plan of care. The patient summary view presents information in such a manner that the patient can easily see what he is trying to achieve, what he should be doing, what he should not be doing, and what should be reported to the patient's healthcare provider. As well, the patient summary view provides information on how well the patient, or the patient's care team is meeting certain goals or outcomes associated with the care plan.

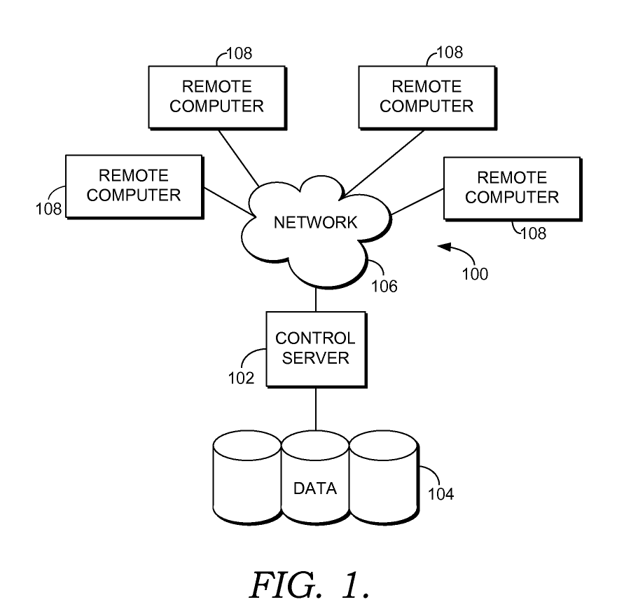

An exemplary computing environment suitable for use in implementing embodiments of the present invention is described below. FIG. 1 is an exemplary computing environment (e.g., medical-information computing-system environment) with which embodiments of the present invention may be implemented. The computing environment is illustrated and designated generally as reference numeral 100. The computing environment 100 is merely an example of one suitable computing environment and is not intended to suggest any limitation as to the scope of use or functionality of the invention. Neither should the computing environment 100 be interpreted as having any dependency or requirement relating to any single component or combination of components illustrated therein.

The present invention might be operational with numerous other purpose computing system environments or configurations. Examples of well-known computing systems, environments, and/or configurations that might be suitable for use with the present invention include personal computers, server computers, hand-held or laptop devices, multiprocessor systems, microprocessor-based systems, set top boxes, programmable consumer electronics, network PCs, minicomputers, mainframe computers, distributed computing environments that include any of the above-mentioned systems or devices, and the like.

The present invention might be described in the general context of computer-executable instructions, such as program modules, being executed by a computer. Exemplary program modules comprise routines, programs, objects, components, and data structures that perform particular tasks or implement particular abstract data types. The present invention might be practiced in distributed computing environments where tasks are performed by remote processing devices that are linked through a communications network. In a distributed computing environment, program modules might be located in association with local and/or remote computer storage media (e.g., memory storage devices).

With continued reference to FIG. 1, the computing environment 100 comprises a computing device in the form of a control server 102. Exemplary components of the control server 102 comprise a processing unit, internal system memory, and a suitable system bus for coupling various system components, including data store 104, with the control server 102. The system bus might be any of several types of bus structures, including a memory bus or memory controller, a peripheral bus, and a local bus, using any of a variety of bus architectures. Exemplary architectures comprise Industry Standard Architecture (ISA) bus, Micro Channel Architecture (MCA) bus, Enhanced ISA (EISA) bus, Video Electronic Standards Association (VESA) local bus, and Peripheral Component Interconnect (PCI) bus, also known as Mezzanine bus.

The control server 102 typically includes therein, or has access to, a variety of non-transitory computer-readable media. Computer-readable media can be any available media that might be accessed by control server 102, and includes volatile and nonvolatile media, as well as, removable and nonremovable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by control server 102. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The control server 102 might operate in a computer network 106 using logical connections to one or more remote computers 108. Remote computers 108 might be located at a variety of locations in a medical or research environment, including clinical laboratories (e.g., molecular diagnostic laboratories), hospitals and other inpatient settings, veterinary environments, ambulatory settings, medical billing and financial offices, hospital administration settings, home healthcare environments, and clinicians' offices. Clinicians may comprise a treating physician or physicians; specialists such as surgeons, radiologists, cardiologists, and oncologists; emergency medical technicians; physicians' assistants; nurse practitioners; nurses; nurses' aides; pharmacists; dieticians; microbiologists; laboratory experts; laboratory technologists; genetic counselors; researchers; veterinarians; students; and the like. The remote computers 108 might also be physically located in nontraditional medical care environments so that the entire healthcare community might be capable of integration on the network. The remote computers 108 might be personal computers, servers, routers, network PCs, peer devices, other common network nodes, or the like and might comprise some or all of the elements described above in relation to the control server 102. The devices can be personal digital assistants or other like devices.

Computer networks 106 comprise local area networks (LANs) and/or wide area networks (WANs). Such networking environments are commonplace in offices, enterprise-wide computer networks, intranets, and the Internet. When utilized in a WAN networking environment, the control server 102 might comprise a modem or other means for establishing communications over the WAN, such as the Internet. In a networking environment, program modules or portions thereof might be stored in association with the control server 102, the data store 104, or any of the remote computers 108. For example, various application programs may reside on the memory associated with any one or more of the remote computers 108. It will be appreciated by those of ordinary skill in the art that the network connections shown are exemplary and other means of establishing a communications link between the computers (e.g., control server 102 and remote computers 108) might be utilized.

In operation, an organization might enter commands and information into the control server 102 or convey the commands and information to the control server 102 via one or more of the remote computers 108 through input devices, such as a keyboard, a microphone (e.g., voice inputs), a touch screen, a pointing device (commonly referred to as a mouse), a trackball, or a touch pad. Other input devices comprise satellite dishes, scanners, or the like. Commands and information might also be sent directly from a remote healthcare device to the control server 102. In addition to a monitor, the control server 102 and/or remote computers 108 might comprise other peripheral output devices, such as speakers and a printer.

Although many other internal components of the control server 102 and the remote computers 108 are not shown, such components and their interconnection are well known. Accordingly, additional details concerning the internal construction of the control server 102 and the remote computers 108 are not further disclosed herein.

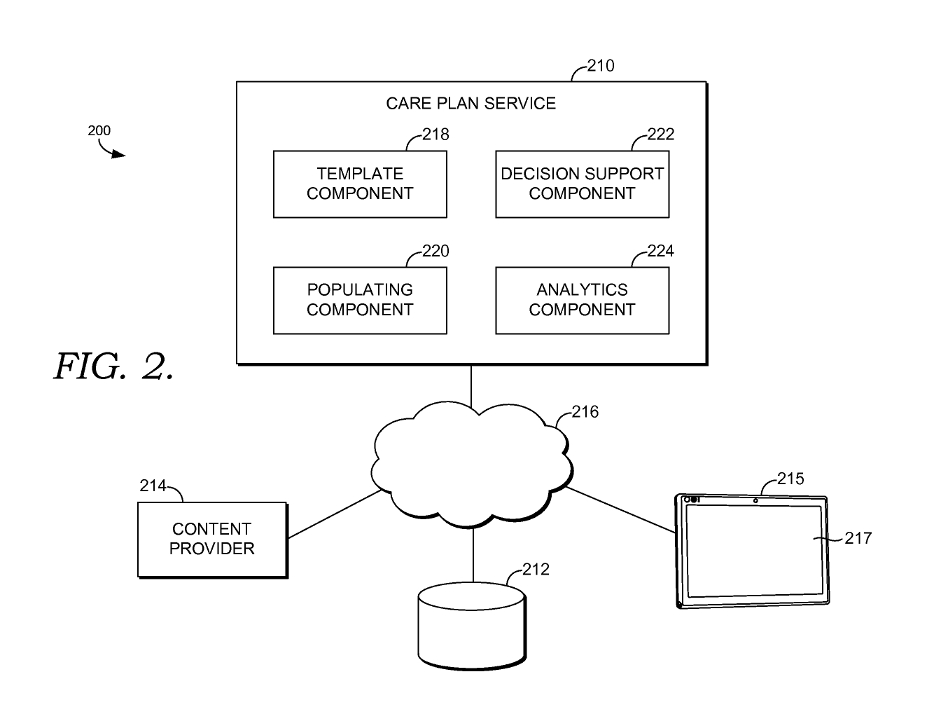

Turning now to FIG. 2, an exemplary computing system environment 200 is depicted suitable for use in implementing embodiments of the present invention. The computing system environment 200 is merely an example of one suitable computing system environment and is not intended to suggest any limitation as to the scope of use or functionality of embodiments of the present invention. Neither should the computing system environment 200 be interpreted as having any dependency or requirement related to any single module/component or combination of modules/components illustrated therein.

The computing system environment 200 includes a care plan service 210, a data store 212, a content provider 214, and an end-user computing device 215 all in communication with each other view a network 216. The network 216 may include, without limitation, one or more local area networks (LANs) or wide area networks (WANs). Such networks are commonplace and, as such, will not be further described herein.

In some embodiments, one or more of the illustrated components/modules may be implemented as stand-alone applications. In other embodiments, one or more of the illustrated components/modules may be integrated directly into the operating system of the care plan service 210 and/or the end-user computing device 215. The components/modules illustrated in FIG. 2 are exemplary in nature and in number and should not be construed as limiting. Any number of components/modules may be employed to achieve the desired functionality within the scope of embodiments hereof. Further, components/modules may be located on any number of servers. By way of example only, the care plan service 210 might reside on a server, a cluster of servers, or a computing device remote from one or more of the remaining components.

The computing system environment 200 is merely exemplary. While the care plan service 210 is illustrated as a single unit, it will be appreciated that the care plan service 210 is scalable. For example, the care plan service 210 may in actuality include a plurality of computing devices in communication with one another. Moreover, the data store 212, or portions thereof, may be included within, for instance, the care plan service 210 and/or the end-user computing device 215 as a computer-storage medium. The single unit depictions are meant for clarity, not to limit the scope of embodiments in any form.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

The data store 212 is configured to store information for use by, for example, the care plan service 210. The information stored in association with the data store 212 is configured to be searchable for one or more items of information stored in association therewith. The information stored in association with the data store 212 may comprise general information used by the care plan service 210. For example, the data store 212 may store information concerning standards-of-care, best practices, or quality initiatives promulgated by a particular healthcare facility or by standards-setting organizations. The standards-of-care, best practices, or quality initiatives may be used by the care plan service 210 to construct different care plans. By way of illustrative example, a standard-of-care may set forth a vaccination schedule for people traveling to a certain country. The care plan service 210 may utilize this standard-of-care when constructing an episodic care plan for people planning on traveling to this country.

The data store 212 may also store frequently-used phrases or terminology associated with care plans such as, for example, descriptions of different care plans and goals associated with different care plans. As well, the data store 212 may store cost information associated with different care plans. For instance, the data store 212 may store cost information for medications, procedures, lab tests, and the like. The cost information may be used by the care plan service 210 to help determine the overall cost of a particular plan. Additionally, the data store 212 may store information used by, for example, an analytics component of the care plan service 210, such as the analytics component 224 of FIG. 2. Such information may include, for instance, plan compliance statistics, how many providers or healthcare facilities have utilized a certain plan, how many providers have discontinued using a certain plan, plan satisfaction statistics, provider ratings of certain plans, plan effectiveness statistics, side effects associated with a certain plan, patient outcomes, and the like.

In one aspect, the data store 212, or a different data store, may store EMRs of patients associated with a healthcare facility. EMRs may comprise electronic clinical documents such as images, clinical notes, orders, summaries, reports, analyses, or other types of electronic medical documentation relevant to a particular patient's condition and/or treatment. Electronic clinical documents contain various types of information relevant to the condition and/or treatment of a particular patient and can include information relating to, for example, patient identification information, images, care plans associated with the patient, alert history, culture results, patient-entered information, drug reactions and/or side effects experienced by the patient, physical examinations, vital signs, past medical histories, surgical histories, family histories, histories of present illnesses, current and past medications, allergies, symptoms, past orders, completed orders, pending orders, tasks, lab results, other test results, patient encounters and/or visits, immunizations, physician comments, nurse comments, other caretaker comments, and a host of other relevant clinical information.

The content and volume of such information in the data store 212 are not intended to limit the scope of embodiments of the present invention in any way. Further, though illustrated as a single, independent component, the data store 212 may, in fact, be a plurality of storage devices, for instance, a database cluster, portions of which may reside on the care plan service 210 and/or the end-user computing device 215.

The content provider 214 is, in one aspect, an independent provider of healthcare-related content (e.g., a third-party content provider). Exemplary third-party content providers include, for example, ELSEVIER® CLINICALKEY™, CERNER®, ISABEL®, MEDCALC®, and UPTODATE®. Third-party content providers provide clinical decision support tools, educational information, differential diagnosis lists, clinical calculators, and the like. Although only one content provider is illustrated in FIG. 2, it is contemplated that the present invention may encompass multiple content providers.

As shown, the end-user computing device 215 includes a display screen 217. The display screen 217 is configured to display information to the user of the end-user computing device 215, for instance, information relevant to communications initiated by and/or received by the end-user computing device 215, information associated with care plans including a catalog of care plans, provider care plan summaries, patient care plan summaries, and the like. Embodiments are not intended to be limited to visual display but rather may also include audio presentation, combined audio/visual presentation, and the like. The end-user computing device 215 may be any type of display device suitable for presenting a graphical user interface. Such computing devices may include, without limitation, a computer, such as, for example, any of the remote computers 108 described above with reference to FIG. 1. Other types of display devices may include tablet PCs, PDAs, mobile phones, smart phones, as well as conventional display devices such as televisions. Interaction with the graphical user interface may be via a touch pad, a microphone, a pointing device, and/or gestures.

As shown in FIG. 2, the care plan service 210 comprises a template component 218, a populating component 220, a decision support component 222, and an analytics component 224. In some embodiments, one or more of the components 218, 220, 222, and 224 may be implemented as stand-alone applications. In other embodiments, one or more of the components 218, 220, 222, and 224 may be integrated directly into the operating system of a computing device such as the remote computer 108 of FIG. 1. It will be understood that the components 218, 220, 222, and 224 illustrated in FIG. 2 are exemplary in nature and in number and should not be construed as limiting. Any number of components may be employed to achieve the desired functionality within the scope of embodiments hereof.

The template component 218 is configured to generate different care plan templates which are subsequently populated with information by the populating component 220. For instance, the template component 218 is configured to generate templates for lifetime care plans that cover the lifetime care of an individual. Lifetime care plan templates may be generated, for example, for patients 0-10 years of age, 10-20 years of age, and 20 years onward until death. Alternatively, lifetime care plan templates may encompass birth to death.

The template component 218 is additionally configured to generate templates for condition care plans that encompass both chronic and temporary conditions such as, for example, pregnancy, hypertension, diabetes mellitus, and the like. As well, the template component 218 can generate templates for episodic care plans that target non-condition based events such as, for example, events that lead to emergency room visits (e.g., lacerations), events requiring non-routine vaccinations, events leading to urgent care visits, and the like.

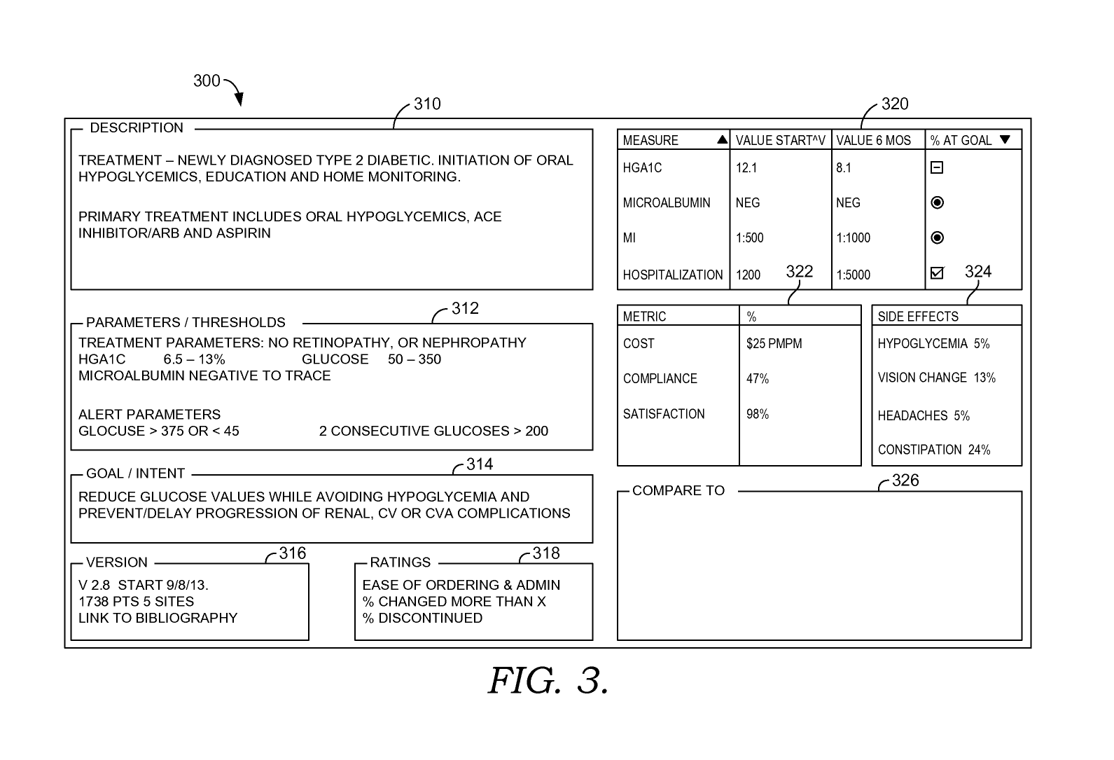

The template component 218 generates the different care plans templates (e.g., lifetime, condition, and episodic) to generally include a uniform set of information designed to facilitate use of the care plan across different healthcare venues that may be caring for a patient. In one aspect, each care plan template may optionally include one or more of a description section, a goals/intent section, a parameters/threshold section, a ratings section, a version section, a side effects section, a comparison section, a metric analysis section, and an outcomes section. Each of these sections will be explained in greater depth below with respect to FIG. 3. Creating a care plan that includes sufficient information that enables its use across different venues, eliminates the need to create a care plan for each venue. For example, a patient who suffered a stroke may initially be cared for in an acute hospital setting and later be transferred to skilled nursing facility for follow-up care. The information included in the different sections of a stroke care plan generated by the care plan service 210 enables its use at both of these venues.

The decision support component 222 is configured determine the particular condition or event that is the subject of a given care plan template and to identify information from, for example, the data store 212 as well as content from the content provider 214 that pertains to the particular condition or event. This information is subsequently populated into the care plan template by the populating component 220. Information identified by the decision support component 222 may comprise standards-of-care, treatment options, recommendations, quality initiatives, and/or best practice paradigms promulgated by a particular healthcare facility or by a national or state standards-setting organization. Content retrieved from the content provider 214 may include decision-support algorithms, clinical decision support tools, educational information, and the like. When more than one treatment option or set of recommendations exists for a given condition or event, multiple care plans may be generated for the condition or event, each covering a different treatment option or set of recommendations.

By way of example, the template component 218 may generate a condition care plan template for diabetes mellitus type II (DM Type II). The decision support component 222 then identifies information and/or retrieves content related to DM Type II. The type of information or content may comprise treatment options, decision-support algorithms, alerting thresholds, reference lab values, medication options, side effects associated with treatment, educational content, and the like.

In another example, when the template component 218 generates a lifetime care plan template, the decision support component 222 then identifies information and/or retrieves content relevant to the lifetime care plan. The information and/or content may comprise activity recommendations, diet recommendations, a schedule for wellness checks, routine screening information, and other health maintenance items. The information and content may be applicable to all patients with similar age and/or gender demographics. The decision support component 222 is further configured to take into account additional patient data, such as any disease conditions that the patient has, when identifying information or retrieving content relevant to the lifetime care plan. For example, a lifetime care plan for a 30-year-old female suffering from DM Type II would include different diet and activity recommendations than a lifetime care plan for a healthy 30-year-old female patient.

In yet another example, when the template component 218 generates an episodic care plan template, such as a care plan for travel vaccinations, the decision support component 222 may retrieve content or identify information relevant to vaccinations schedules for different countries. In another example, for an episodic care plan template for simple lacerations, the decision support component 222 may identify best practices or standards-of-care related to simple wound care.

The analytics component 224 is configured to perform an analysis of a given care plan. The results of the analysis are subsequently populated into the care plan by the populating component 220. The analytics component 224 may use information stored in association with, for example, the data store 212 and/or content from the content provider 214 when carrying out the analysis. Types of information generated by the analytics component 224 for a particular plan may include patient side effects associated with the plan, plan costs, plan compliance statistics, patient satisfaction with the plan, overall patient outcomes associated with the plan, provider ratings regarding ease of ordering and administration of the plan, how often the plan was discontinued by providers, how often the plan was modified or changed, and the like.

When multiple care plans covering different treatment options are generated for a particular condition or event, the analytics component 224 is further configured to perform a comparative analysis of the different care plans. For instance, different care plans may be compared by the analytics component 224 based on cost, plan compliance, patient satisfaction, side effects, treatment outcomes, ratings, and the like.

The populating component 222 is configured to populate the information generated by the analytics component 224 and the decision support component 222 into the different sections of the appropriate care plan template. The populating component 222 may also use frequently-used phrases or terminology stored in association with the data store 212 to populate, for example, the care plan description and/or goals/intent sections of the template. The populating component 222 is further configured to populate a given care plan with information such as when the plan was first created, the current version number of the plan, how many patients are currently using the plan, how many healthcare facilities are using the plan, and the like. This information may be stored in association with the data store 212.

Turning now to FIG. 3, FIG. 3 depicts an exemplary care plan 300 for the condition DM Type II. The care plan 300 was generated, for example, by a care plan service such as the care plan service 210 of FIG. 2. The care plan 300 may be part of a catalog of care plans that are accessed by the healthcare provider using, for example, the end-user computing device 215. Additionally, the care plan 300 may be one of several that are available for the condition DM Type II. The care plan 300 includes information that enables the provider caring for a patient suffering from DM Type II to quickly decide if the care plan 300 is appropriate for the particular patient. Although FIG. 3 depicts a care plan for the condition DM Type II, it is contemplated that other condition-based plans as well as lifetime care plans and episodic care plans would include similar categories of information.

The care plan 300 includes a description section 310, a parameter/threshold section 312, a goals/intent section 314, a version section 316, a ratings section 318, an outcome section 320, a metrics section 322, a side effects section 324, and a comparison section 326. The section labels shown in FIG. 3 are exemplary only. Any label that accurately describes the information contained within a section is contemplated as being within the scope of the invention. Additionally, more or less sections than those shown are contemplated as being within the scope of the invention.

The description section 310 includes an overall description of the type of patient the plan is designed for (e.g., newly diagnosed Type II diabetic) and a general description of the plan's treatment algorithm (e.g., oral hypoglycemic, education, and home monitoring). If the provider viewing the plan is caring for a patient that has chronic DM Type II, the provider would quickly be able to ascertain that the care plan 300 may not be appropriate for the provider's patient.

The parameters/threshold section 312 sets forth treatment parameters and alert parameters. The treatment parameters comprise various lab values or patient symptoms that should be met (or not met) by the patient in order for the care plan 300 to be considered a viable option for the patient. Thus, if the patient is experiencing retinopathy, nephropathy, has glucose values greater than 350, HGA1c levels greater than 13%, or more than a trace of microalbumin in his or her urine, the provider can easily decide that the care plan 300 would likely not be sufficient for the patient. The alert parameters indicate values that if met (or not met) will cause an alert to be generated.

The goals/intent section 314 includes overall goals associated with the plan 300. The version section 316 provides information on the version associated with the care plan 300, when the particular version was implemented, how many patients are currently on the plan 300, how many healthcare facilities are utilizing the plan 300, and links to any resources associated with the plan 300. The links may include links to content from content providers that was used to generate the plan 300. The rating section 318 may comprise a composite provider rating of the plan 300. For example, the plan 300 may be rated on ease of ordering and administration. Other rating scenarios are contemplated as being within the scope of the invention. The ratings section 318 may also include information on how often the plan 300 was changed or modified and what percentage of providers or healthcare facilities discontinued use of the plan.

The outcomes section 320 includes information about how other people on the plan 300 have performed. For instance, for the measure HGA1c, people on the plan have shown a decrease in this measure after being on the plan for six months. The outcomes section 320 may also include an indication of, for instance, the percentage of patients who have met the threshold parameter of having their HGA1c between 6.5% and 13% as delineated in the parameters/threshold section 312.

The metrics section 322 includes information on plan cost, overall patient compliance with the plan 300, and overall patient satisfaction with the plan 300. The side effects section 324 includes information on side effects, if any, experienced by patients who are on the plan 300. The comparison section 326 allows the provider to select a different care plan (or multiple different care plans) for the condition DM Type II and perform a comparison between the different care plans. Plans may be compared based on, for example, costs, patient compliance, patient outcomes, patient satisfaction, goals/intents, ratings, parameters/thresholds, side effects, and the like. This features enables providers to quickly decide which plan among several similar plans is the best option for the patient.

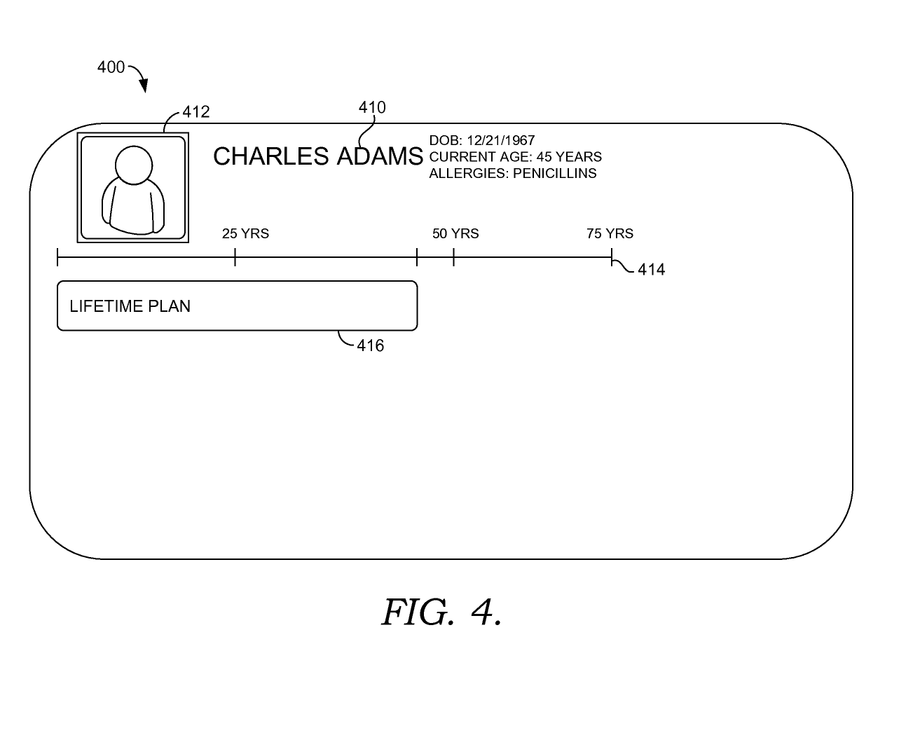

FIG. 4 depicts an exemplary GUI 400 that is presented to, for example, a healthcare provider on an end-user computing device such as the end-user computing device 215 of FIG. 2. The GUI 400 depicts one or more care plans that been implemented for a patient (using, for example, the user interface of FIG. 3) over the course of the patient's life. The GUI 400 includes the patient's name and identifying information 410, a picture of the patient 412, a timeline 414 covering a time span in years, and a graphical depiction of a lifetime care plan 416 that has been selected and initiated for the patient 410. The lifetime care plan 416 is depicted to graphically illustrate at what age the patient was when the care plan 416 was started and how long the plan has remained in effect. In this case, the lifetime care plan 416 was initiated when the patient 410 was born and has remained in effect throughout the patient's life (e.g., for 45 years).

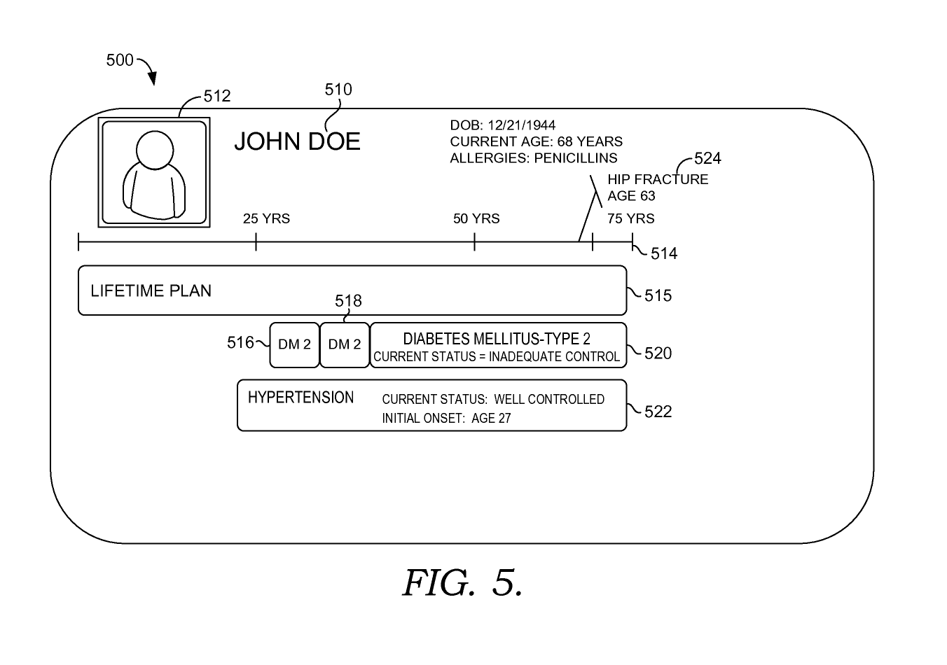

FIG. 5 depicts another exemplary GUI 500 for a patient who has had multiple care plans throughout his life. The GUI includes the patient's name and identifying information 510, the patient's picture 512, and a timeline 514 covering a time span and measured in years. The timeline 514 includes an indication of an event 524 (e.g., hip fracture) that occurred when the patient 510 was 63-years-old. The event 514 may be selectable. For instance, the provider could select the event 514 and view an episodic care plan that was initiated for the hip fracture. The GUI 500 further includes care plans 515, 516, 518, 520, and 522 that have been selected and initiated for the patient 510 over the course of the patient's lifetime. Each of the care plans 515, 516, 518, 520, and 522 is graphically depicted such that the size of the depiction is commensurate with how long the plan was (or is) in effect for the patient 510. The care plan 515 is a lifetime care plan. The lifetime care plan 515 was initiated for the patient 510 when he was born and remains in effects until the current point of time. As described above, the lifetime care plan 515 may include diet and activity recommendations as well as health maintenance items such as screening checks, vaccinations schedules, and the like.

The care plans also include DM Type II care plans 516, 518, and 520 that have been implemented for the patient 510 at varying points in the patient's life. For instance, the DM Type II care plan 516 was initiated for the patient 510 when the patient 510 was approximately 30 years of age and remained in effect for approximately 5 years. The DM Type II care plan 518 was initiated after the care plan 516 and remained in effect for approximately 5 years before being discontinued. The patient 510 is currently on the DM Type II care plan 520 and has been for approximately 35 years. The current DM Type II care plan 520 includes an indication that the patient's condition is currently not adequately controlled by the plan 520.

The care plans further include the care plan 522 for the patient's condition of hypertension. The care plan 522 was initiated for the patient 510 when the patient was approximately 27 years of age (as indicated on the display of the care plan 522) and remains in effect at the current time. The care plan 522 includes an indication that the patient 510 is well controlled on the care plan 522.

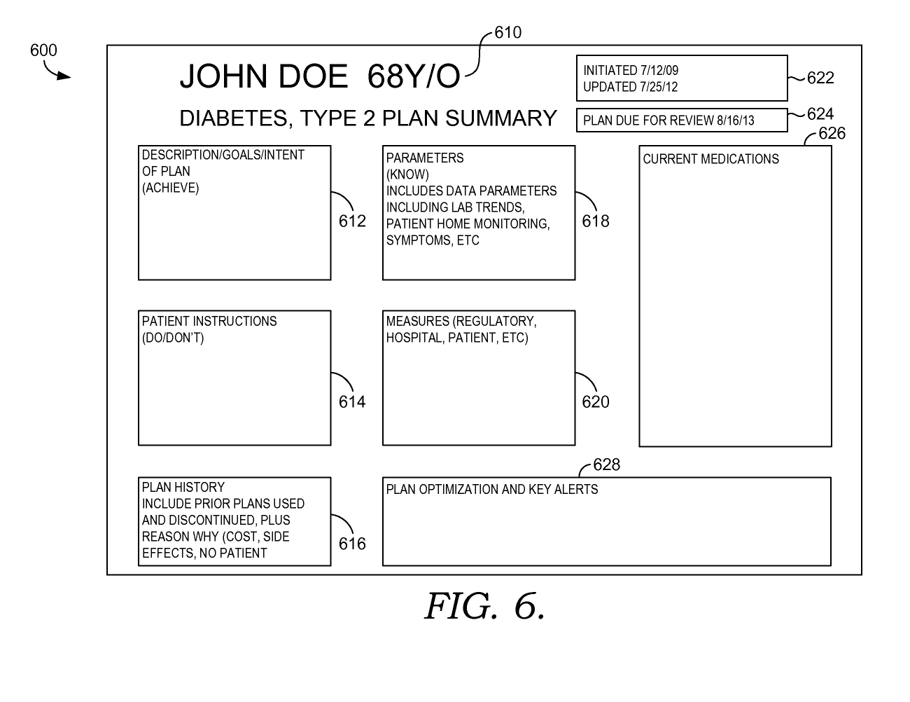

As stated, each of the care plans shown in FIGS. 4 and 5 is selectable. Selection of a care plan initiates a provider plan summary view as shown in FIG. 6. FIG. 6 depicts an exemplary provider plan summary view 600 for a patient 610 having the condition DM Type II. Additional provider plan summary views for other condition-based care plans, episodic care plans, and/or lifetime care plans are also contemplated as being within the scope of the invention. The summary view 600 may include some or all of the information that was presented in the care plan shown in FIG. 3. For example, the summary view 600 may include a description/goals/intent section 612 which includes much of the same information as shown in the description section 310 and the goals/intent section 314 of the care plan 300. The description/goals/intent section 612 may be labeled using other labels such as, for instance, an “Achieve” label to indicate what the care plan is attempting to achieve.

The summary view 600 also includes a patient instruction section 614 (otherwise known as the “Do/Don't” section. The patient instruction section 614 may include information on what the patient is expected to do, or not do, in order to meet parameters or goals associated with the care plan. The summary view 600 further comprises a plan history section 616 that presents information detailing other plans used by the patient to treat DM Type II, when the respective plans were discontinued, and why the plans were discontinued. A parameters section 618 (also known as the “Know” section) of the summary view 600 may include information similar to that shown in the parameters/threshold section 312 of FIG. 3 along with other types of information. For example, the parameters section 618 may include data parameters associated with the care plan, lab trends, patient symptoms, patient-inputted information, and the like. A measures section 620 may include different regulatory, healthcare facility-specific, and/or patient-specific measures for the condition DM Type II.

Continuing, the summary view 600 may include section 622 that indicates when the care plan was initiated and when it was last updated. Similarly, section 624 indicates a pending review data of the plan. The summary view may further include a current medications section 626. The current medications section 626 may include all medications that the patient 610 is currently taking. In another aspect, the medications section 626 may include just those medications related to the condition DM Type II. An option may be provided with the current medications section 626 to toggle between all medications and medications for treating DM Type II. As well, the summary view 600 may also comprise a plan optimization and key alerts section 628 that displays alerts associated with the care plan and any changes made to the care plan by the provider in order to further optimize the plan for the patient 610. More or less sections than those shown are contemplated as being within the scope of the invention. Further, for plans that are no longer in effect for the patient, the summary view may contain an abbreviated set of information.

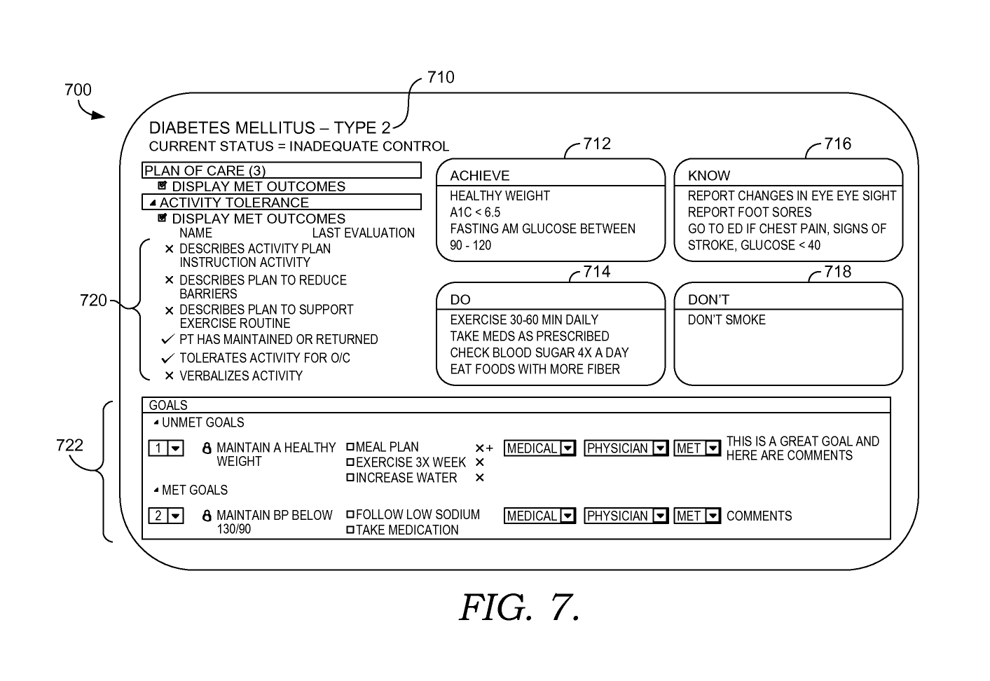

Besides provider care plan summaries as shown by the summary view 600, plan information may also be presented to patients utilizing, for example, a patient portal. FIG. 7 depicts an exemplary patient summary view 700 of the patient's care plan for DM Type II. Patient summary views may be limited to a particular patient condition or they may comprise a summary of all of the care plans currently being used to treat the patient. Any and all such variations, and any combination thereof, are contemplated as being within the scope of the invention.

The patient summary view 700 identifies the condition 710 and a current status of the condition 710. The patient summary view 700 further includes at least four sections labeled as “Achieve” 712, “Do” 714, “Know” 716, and “Don't” 718. The labels are used to indicate what type of subject matter is presented in each of the sections 712, 714, 716, and 718 and include information that is easily understood by the patient. The “achieve” section 712 includes parameters that, if achieved by the patient, will optimize treatment of the condition 710. The “do” section 714 includes activity recommendations and/or diet recommendations for the condition 710. The “know” section 716 includes information on when to alert the patient's healthcare provider, and the “don't” section 718 includes information on what the patient should refrain from doing in order to optimize treatment of the condition 710.

The patient summary view 700 may also include an outcomes section 720 that provides an indication of how well the patient has achieved various outcomes associated with the condition 710. The outcomes may include various educational modules related to the condition 710. The patient summary view 700 may additionally comprise a goals section 722 that includes different goals related to the condition 710 and indications of whether the goals have been met or not met. The goals may be patient-specific goals, goals associated with the healthcare facility caring for the patient, and/or goals associated with the patient's healthcare provider or provider team. The patient summary view 700 enables the patient to enter comments related to the goals section 722 and indicate whether the comments are applicable to the patient, the healthcare facility, or the provider.

Although not shown in FIG. 7, it is contemplated that the patient summary view may also include a comparison section similar to the comparison section 326 shown in FIG. 3. The comparison section would allow the patient to compare a limited set of different care plans for a given condition or event. The number of care plans available for comparison by the patient may be predetermined by the healthcare provider such that only care plans that are feasible for the patient can be compared. Thus, if the patient is focusing on cost savings, the patient would be able to compare the cost of different plans and to compare the effectiveness of each of the plans. Providing a comparison section enables the patient to become an active participant in his or her own health care.

The present invention has been described in relation to particular embodiments, which are intended in all respects to be illustrative rather than restrictive. Further, the present invention is not limited to these embodiments, but variations and modifications may be made without departing from the scope of the present invention.

What is claimed is:

1. One or more computer-storage media having computer-executable instructions embodied thereon that, when executed by a computing device, perform a method of generating a care plan for a patient, the method comprising:
receiving a request that a care plan pertaining to a disease condition or to a clinical event be generated for the patient;
generating a care plan template comprising a plurality of sections;
determining a plurality of care plans relating to the disease condition or to the clinical event;
determining a first care plan of the plurality of care plans;
parsing the first care plan based on the plurality of sections and populating the parsed first care plan into the plurality of sections; and
communicating the populated care plan template for presentation on a user interface.

2. The media of claim 1, wherein the request is received from a computing device associated with a clinician caring for the patient.

3. The media of claim 1, wherein the plurality of sections comprises at least a description section, a goals/intent section, a parameters section, an alerting section, a side effects section, and a patient outcomes section.

4. The media of claim 3, wherein the plurality of sections further comprises at least a care plan ratings section, a care plan version section, a care plan comparison section, and a care plan metric section.

5. The media of claim 1, wherein the plurality of care plans relating to the disease condition or to the clinical event is generated in part based on information supplied by third-party content providers.

6. The media of claim 1, wherein determining the first care plan of the plurality of care plans comprises determining that the first care plan is associated with one of a low cost, high patient satisfaction, high rate of patient compliance, or positive patient outcomes.

7. A computerized method carried out by at least one server having at least one processor for determining a set of care plans that have been implemented for a patient over a predefined period of time and presenting the set of care plans on a graphical user interface, the method comprising:
receiving a request to view care plans that have been implemented for the patient over a predefined period of time;
determining, using the at least one processor, a set of care plans associated with the patient during the predefined period of time, the set of care plans stored in association with the patient's electronic medical record;
generating a graphical depiction of each care plan in the set of care plans; and
presenting each graphical depiction on the graphical user interface, wherein the each graphical depiction is presented in association with a timeline, and wherein the each graphical depiction's location along the timeline is indicative of when the each graphical depiction's respective care plan was in effect for the patient.

8. The method of claim 7, wherein the request is received from a computing device associated with a clinician caring for the patient.

9. The method of claim 7, wherein the predefined period of time comprises one of birth to present, 0 to 10 years of age, 10 to 20 years of age, or 20 years to present.

10. The method of claim 7, wherein the set of care plans comprises one or more of care plans relating to one or more disease conditions, care plans related to episodic care events, or care plans related to lifetime care of the patient.

11. The method of claim of claim 7, wherein the each graphical depiction of the each care plan comprises a geometric shape.

12. The method of claim 11, wherein a size of the each geometric shape corresponds to a length of time in which the particular care plan represented by the each geometric shape was/is in effect for the patient.

13. The method of claim 12, wherein the each graphical depiction further comprises an indicator of a name of the each graphical depiction's respective care plan.

14. The method of claim 13, wherein the each graphical depiction further comprises an indication of the patient's health status as related to the each graphical depiction's respective care plan.

15. The method of claim 7, wherein the each graphical depiction is selectable, and wherein upon selection of a particular graphical depiction, a care plan associated with the each graphical depiction is presented.

16. A computing system for generating a care plan for a patient, the system comprising:
a computing device having one or more processors and one or more computer-storage media; and
a data store coupled with the computing device,
wherein the computing device:
receives a request to generate a care plan for the patient corresponding to one of a disease condition or a clinical event;
generates a uniform template having a plurality of sections;
determines a plurality of different care plans for the one of the disease condition or the clinical event;
analyzes the plurality of different care plans to determine a first care plan based on one or more of cost of the first care plan, patient compliance with the first care plan, patient satisfaction with the first care plan, or patient outcomes associated with the first care plan;
parses information associated with the first care plan based on the plurality of sections and populates the parsed information into the plurality of sections of the template; and
communicates for presentation on a user interface the populated template.

17. The system of claim 16, wherein the request to generate the care plan for the patient is received from a computing device associated with a clinician caring for the patient.

18. The system of claim 16, wherein the plurality of different care plans is determined based in part on content provided by third-party content providers.

19. The system of claim 18, wherein the content comprises at least one or more different treatment recommendations for the one of the disease condition or the clinical event.

20. The system of claim 18, wherein the plurality of different care plans is further determined based on health information associated with the patient.
